(19) United States
(12) Patent Application Publication
(10) Pub. No.: US 2013/0326604 A1
(43) Pub. Date: Dec. 5, 2013

(54) RHYTHM-BASED AUTHENTICATION

(71) Applicant: Geoffrey R. HIRD, Cupertino, CA (US)

(72) Inventor: Geoffrey R. HIRD, Cupertino, CA (US)

(73) Assignee: CA, Inc., Islandia, NY (US)

(21) Appl. No.: 13/484,836

(22) Filed: May 31, 2012

(51) Int. Cl. G06F 21/00

(52) U.S. Cl. 726/7

(57) ABSTRACT

Provided herein are systems and methods for using rhythm to provide user authentication. Use of the systems and methods herein include converting rhythm information associated with (e.g., input by) an authorized user to a first vector that includes a representation of the rhythm information. An access attempt is then made on the computing system whereupon additional rhythm information associated with the access attempt is received and converted into to a second vector. The first vector is then compared to the second vector to determine if the access attempt is allowed.

### BACKGROUND

Multi-factor authentication is a useful way to increase security. For example, three popular factors for multi-factor authentication are “something you know,” “something you have,” and “something you are.” The essence of multi-factor authentication is that attackers must make several independent acts of theft, thereby lowering their probability of overall success. Accordingly, the addition of factors to authentication schemes would be beneficial to create robust security solutions for enterprises, user devices, or other computing environments.

### SUMMARY

Provided herein are systems and methods for using rhythm to provide user authentication. In some implementations, use of the systems and methods herein include converting rhythm information associated with (e.g., input by) an authorized user to a first vector that includes a representation of the rhythm information. An access attempt is then made on the computing system whereupon additional rhythm information associated with the access attempt is received and converted into to a second vector. The first vector is then compared to the second vector to determine if the access attempt is allowed.

In an embodiment, there is provided a method for providing authentication to a computing system, the method executed by a processor configured to perform a plurality of operations, the method comprising: obtaining a first vector that includes information relating to a rhythm of a first plurality of user input events, wherein the first vector is associated with a user authorized to use the computing system; receiving a second plurality of user input events associated with an attempt to access the computing system; converting the second plurality of user input events to a second vector, wherein the second vector includes information relating to a rhythm of the second plurality of user input events; comparing the first vector to the second vector; and determining if a match exists between the first vector and the second vector.

In an embodiment, there is provided a system to provide authentication to a computing system, comprising: a data storage device; and a processor configured to: obtain a first vector that includes information relating to a rhythm of a first plurality of user input events, wherein the first vector is associated with a user authorized to use the computing system; receive a second plurality of user input events associated with an attempt to access the computing system; convert the second plurality of user input events to a second vector, wherein the second vector includes information relating to a rhythm of the second plurality of user input events; compare the first vector to the second vector; and determine if a match exists between the first vector and the second vector.

In an embodiment, there is provided a method for providing authentication to a computing system, the method executed by a processor configured to perform a plurality of operations, the method comprising: receiving a plurality of user input events associated with an attempt to access the computing system; converting the plurality of user input events to a first vector, wherein the first vector includes information relating to a rhythm of the plurality of user input events; comparing the first vector to a second vector, the second vector information including information relating to a rhythm of another plurality of user input events associated with a user authorized to use the computing system; and determining if a match exists between the first vector and the second vector.

Various other objects, features, and advantages of the invention will be apparent through the detailed description and the drawings attached hereto. It is also to be understood that both the foregoing general description and the following detailed description are exemplary and not restrictive of the scope of the invention.

### BRIEF DESCRIPTION OF THE DRAWINGS

FIGS. 1A and 1B illustrate example environments wherein systems for providing user authentication using rhythm information may reside, according to various implementations.

FIG. 2 is an illustration of an example process for providing user authentication using rhythm information, according to various implementations.

### DETAILED DESCRIPTION

In some implementations, the systems and methods provided herein enable the use of rhythm information for authentication of users to computing systems or devices. The use of rhythm is somewhat like a password in that it is something you know and somewhat like a biometric factor in that it is something you are. Furthermore, the use of rhythm information provides an alternative or additional factor to authentication procedures and therefore provides for more options when designing authentication schemes. Furthermore, in some instances, users may find rhythm information easier to remember (i.e., it is not another password among many). The use of rhythm information has security advantages over passwords because the user is not likely to write the rhythm down where it can be discovered (especially if the rhythm is invented by the user). Other benefits may also be realized using rhythm for authentication. For example, in some instances, entry of rhythm information may be easier when driving, attending meetings, or otherwise performing tasks while logging into a computing system or device. Furthermore, entering rhythm information during an authentication process may be easier for handicapped users.

Accordingly, systems and methods enabling authentication to a computing environment or device using rhythm-based information are provided herein. The systems and methods herein may be used to provide user authentication and access to an application environment a user device (e.g., a smart phone, tablet, desktop, laptop or other computing device), a single service, a website, or may otherwise be used in authentication of users to computing systems or settings.

In some implementations, the rhythm information captured in both an initial stage for setting a user's rhythm authentication protocol and received rhythm information from a user attempting to access a computing system may include both DOWN and UP keystroke events for depressed key (, these UP and DOWN events may be derived from touchscreen data when used instead of a keyboard) which represent more than just pure rhythm information. These UP and DOWN keystroke events add an element of unconscious biometric signature to a user's conscious choice.

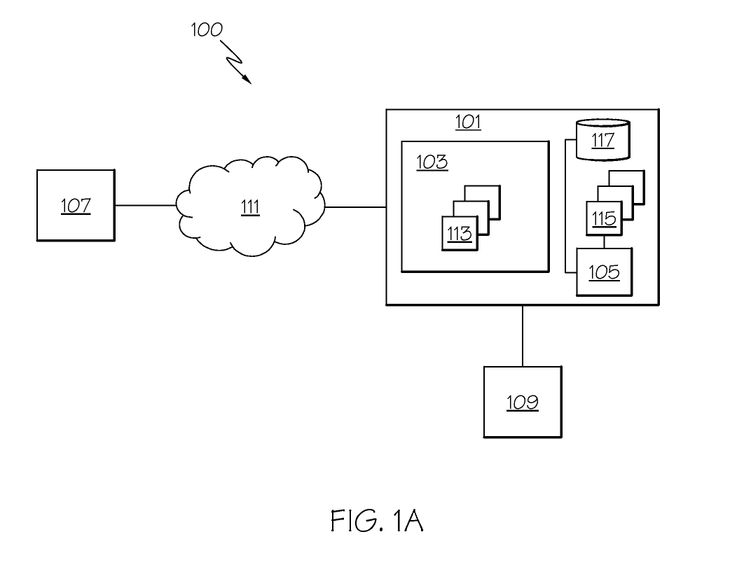

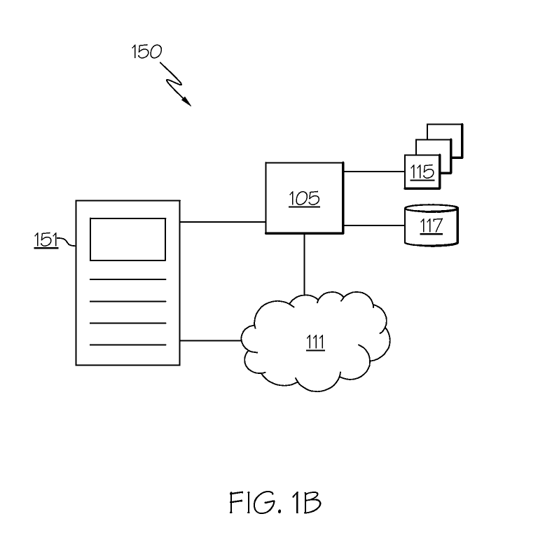

FIG. 1A illustrates an environment 100, which is an example of an environment in which a system for user authentication may reside. In some implementations, environment 100 may include a server system 101, a computing environment 103, an authentication module 105, an external user device 107, an internal user device 109, a network 111, and/or other elements. In some implementations, server system 101 may be or include one or more servers or other computing devices having one or more processing devices (such as, for example, microprocessors) and associated memory/storage devices (such as, for example, hard discs, RAM, ROM, flash memory, EEPROM, and/or other volatile or non-volatile memory). Server system 101 may be or include a single server device or may include multiple servers which may (or may not) be distributed and connected via one or more networks (e.g., network 107).

In some implementations server system 101 may host or support a computing environment 103. Computing environment 103 may be or include an enterprise or other computing environment that hosts one or more services or applications 113. Services/applications 113 may be or include one or more applications, databases, and/or other computing services that can be accessed by one or more computing devices (e.g., user devices 107 or 109).

In some instances, access to computing environment 103 may be restricted to only certain users. Accordingly, computing environment 103 may include an authentication module 105, which may gate access by users to application environment 103. In some implementations, as described herein, authentication module 105 may provide a login or authentication procedure to users attempting to access computing environment 103. In some implementations, authentication module 105 may support, provide or otherwise utilize one or more graphical user interfaces (GUIs) 115 that enable authentication/login features. For example, a GUI 115 utilized by authentication module 105 may prompt a user to enter information that is used to authenticate the users to application environment 103. Accordingly, a GUI 115 may enable authentication module to receive login information from a user attempting to access application environment 103. Other methods of receiving login information may be used.

Authentication module 105 may include or have access to a database 107 or other data storage system for storing login information (e.g., rhythm information), and/or other information necessary to provide authentication procedures.

FIG. 1B illustrates an environment 150, which is an example of an environment in which a system for user authentication may reside. Environment 150 may include a user device 151 to which that a user must be authenticated before the user can access user device 151. For example, user device 151 may be or include a server, a desktop computer, a laptop computer, a tablet computer, a smart phone, a cell phone, a personal digital assistant, an electronic organizer, and/or any other computer implemented device to which user authentication is desirable. User device 151 may include one or more processing devices (e.g., microprocessors), memory, ports, and/or other computing elements for performing the features and functions described herein and/or other features and functions.

Authentication module 105 having one or more GUI's 115 and database 117 may also be used in environment 150. For example, in some implementations, authentication module 105 may be located on user device 105. In some implementations, part or all of authentication module 105 and/or its features and functions may be located and/or accessed remotely from user device 151 (e.g., accessible via network 111).

In some implementations, the login information entered by a user, and received by authentication module 105, may include rhythm information. For example, while typical authentication methods utilize at least a username and a password to identify and authenticate a user, authentication module 113 may include the use of rhythm-based information in place of or in addition to a username, a password, and/or other information. In some implementations, rhythm information may include keystroke or touch events received on an input device (e.g., keyboard, mouse, of a user device (e.g., user device 107, 109, 151). In some implementations, the UP and DOWN events associated with user keystrokes on a keyboard a touchscreen) may also be used as part of rhythm events.

Such rhythm information, including UP and DOWN keystroke events, may also be used with touchscreen devices. For example, when a user places her finger on and off a touchscreen on a smart-phone tablet computer, or other computing device, the device software registers touch events that contain various kinds of information. The exact nature of these events (including low-level information and the abstractions available to applications) can vary across devices. For example, touch events involve/invoke electrical signals within a device or system which creates temporarily held state information that is not directly available to applications. This is low level information, and can be very different in different devices. For example, an application might register an “event handler” and thereby obtain a cleaned-up version of the touch event. Some devices use the event handler model, but an application may obtain simplified, cleaned-up information about a touch event in other ways, as would be understood to those having skill in the art. The nature of this event information may evolve with newer device models. As discussed herein, common smart phones tablet devices and other computing devices having touchscreens may enable derivation of UP events and DOWN events, together with both the time and the (x, y) coordinates at which the event occurred. Tapping on a touchscreen thus produces a sequence of these values. Future generations of touchscreen devices may also provide the force with which the user presses on the screen. While some touchscreens may be different, at a minimum all provide time markers associated with touch events and therefore can provide the UP and DOWN events needed to receive rhythm information that can be cross-correlated with keystrokes.

As mentioned above, the data associated with touch events may include spatial information. Thus, the spatial information may be an additional authentication factor. For example, the user may need to enter the touch events at one or more specific spatial locations (e.g., touch a certain spatially arranged sequence of keys or portions of touch screen) or at a plurality of relatively spaced locations (e.g., a touch event at a certain relative location to another touch event, irrespective of their specific location). Consequently, the spatial information can add another layer of difficulty to compromising the security of a device.

The spatial information may be based, for example, on fixed input areas such as fixed positions of keys on a keyboard or digits on a number pad. A touch screen may be divided into what are effectively fixed positions such as quadrants or a number pad that may be displayed to a user when the user seeks to access the computing system.

In another example, spatial information may be recorded based on a precise location of a received input in the form of, for example, (x, y) coordinates. The spatial information may be recorded based on relative locations between the inputs (whether, e.g., input freely (such as on any active location on a touch screen) or input relative to at least specific location (e.g., a first touch event should be at a specific location and one or more others are relative to the location of the first touch event). Further, recording spatial information may allow recording of a motion a user makes during a touch event. This may allow a user to draw a line or shape as part of the password.

Accordingly, both keyboard and touchscreen-based input devices may be used to capture rhythm information. As discussed herein, rhythm information may be used in conjunction with password or username character input, or separate therefrom.

In some implementations, user input rhythm information is distilled and represented in a form suitable for rhythm analysis (i.e., for storage as authentication information to which user provided login attempts are compared). In some implementations, rhythm information may be stored as a vector of times that capture a sequence of taps, wherein each time entry corresponds to a tap (not distinguishing between the beginning and end of a tap). In another example, rhythm information is stored as a vector where successive pairs of times represent DOWN and UP events. In another example, rhythm information is stored as two vectors, corresponding to tapping with both hands (both vectors could be incorporated into a suitable single vector, if desired).

At an abstract level, rhythm information may be represented as a vector, though actual representations in a database or algorithm may take different forms. As used herein, the term “vector” may refer to some other data structure used to store rhythm information.

In another example, a method for storing rhythm information may use a more elaborate format that captures a keyboard-based rhythm as a sequence of entries such as, for example, a series of triples. The first element of the triple may represent a specific key, the second element of the triple may represent a state of the key, and the third element of the triple may represent a duration that the key was in the state. For example, in a system that represents keys by their ASCII character codes for the first element (e.g., 42 represents “B”), and uses “0” and “1” to represent a “down” state and an “up” state respectively for the second element, the triple <42, 0, 5.69> may describe a 5.69 second depression of the “B” key. A sequence of these triples may represent a sequence depressions and releases of various keys. This example provides a vector that is able to capture a rhythm tapped on a keyboard using the fingers of two hands, where the length of time that a key was depressed is considered a part of the rhythm. Note that in this last example the keycode is used merely to distinguish different fingers. However, unlike pure “keystroke dynamics” which take the entry of specific keys into account, the systems and methods described herein utilize rhythm analysis. Accordingly, in some implementations, the specific key pressed may be factored out and rhythm only may be used for authentication. This may also apply to touchscreen entry, where touch coordinates serve to distinguish different fingers used for tapping, only the rhythm information may be used for authentication.

When UP and DOWN events are captured (e.g., when rhythm information is input using a keyboard) and rhythm information alone is used (i.e., without capturing the specific keys used) the up and down movements of the person's finger used to depress and release the keys may be used in the rhythm information and the UP and DOWN may be used capture the length of time that a key/finger is held down (e.g., the length of time each key is depressed need not be standard and may be either a staccato event or have some non-zero duration).

Reference rhythm information used for user logins may be stored in a database (e.g., database 117 associated with authentication module 105) and rhythm inputs received during an authentication attempt may be compared to the stored rhythm data at authentication time. The stored reference information may come from samples generated by the user when the user enrolls in the system. The system may prompt the user, “Tap in your chosen rhythm six times.” However, different prompts and initial samples may be used. For example, the system might use one reference sample. In another example, the system might obtain a set of samples when the user registers initially, and add future samples generated during actual logins to the set of samples. The database of stored rhythm information may contain a set of sample vectors collected in a manner described above, or the results of processing a set of sample vectors into a form that speeds up the testing of a fresh vector.

In some implementations, the authentication scheme used by the systems and methods herein may include an initial stage wherein a user provides, selects, or is assigned their login information (e.g., a username, password, answers to personal questions, etc.). Accordingly, the rhythm information associated with a specific user may also be provided by a user or otherwise assigned/determined at this initial stage.

For example, in some implementations, the user may provide, select or be assigned a specific user name in the initial stage. From then on, the username will be associated with the user and will serve to identify the user from among other users. In some implementations, the initial stage may also include the user providing, selecting, or being assigned a password. The password may serve to authenticate the specific user identified by the username. In some implementations, rhythm information may also be provided at the initial stage and may also be used as an additional authentication measure. However, in some implementations, rhythm information may be used alone for authentication (e.g., when a user is unlocking a cell phone, tablet computer, or other device) and one or more of the username or password may be omitted from the authentication scheme. In some implementations, if a username and/or password is used in an authentication process, they may be established separately (i.e., the user may be assigned or may choose/input them in separate input events).

In some implementations, the rhythm information may be collected and saved during an initial stage upon a single instance of a user entering it. However, in some implementations, the rhythm information may be collected and saved upon the user entering it multiple times. For example, in some implementations, the user may be prompted to enter the rhythm information two or more times, wherein each entry is factored into the information stored by authentication module as rhythm information. The use of multiple instances of a user entering the rhythm information may assist in establishing thresholds for the rhythm information. For example, because the precise rhythm of entry may vary each time the user enters their password, these thresholds may be used to distinguish valid rhythm information from invalid rhythm information. A person having ordinary skill in the art will recognize that a variety of statistical techniques may be used to establish the thresholds.

There are various ways in which a rhythm can be entered or specified. For example, in some instances, the user may be prompted to enter their rhythm information by typing a single key (e.g., a printing character like “A” or a shift character like “Control”). In some implementations, the key that the user must use may be specified by authentication module 105 and this specified key may be communicated to the user. In some embodiments, the user may select any key to provide rhythm information. In another example, the user may be able to utilize a number of different keys when entering rhythm information. In some implementations, when a user is interacting via a touchscreen, the user may be able to enter rhythm information by tapping the rhythm onto the touchscreen. In some implementations, providing of initial rhythm information on a touchscreen device may enable the user to tap the rhythm information at any point on the screen (e.g., a first one beat in the middle of the screen and the next beat in a particular corner). In this instance, the (x, y) coordinates may not be used in rhythm storing or matching analysis. However, in some implementations, the location on a touchscreen on which the rhythm is entered my be significant, and therefore the (x, y) coordinates may be used. Mouse buttons or other entry devices may also be used by enable users to enter rhythm information.

In some implementations, when the rhythm information is not otherwise associated with a user's username or password, the initial stage associated with a user authentication scheme (i.e., where the user provides, selects, or is assigned their username and/or password) may include a portion wherein the user is prompted to enter such rhythm information. As described above, when providing rhythm information in addition to or in place of a password or username, the user may provide the rhythm information several times so that authentication module 105 can establish thresholds with respect to the rhythm information.

After all authentication information is provided in the initial stage of an authentication scheme, the information may be stored by authentication module 105 (e.g., in database 117) for use when user access is attempted. Use access may be attempted by one or more computing devices such as, for example, an external user device 107 or an internal user device 109. In some implementations, an external user device 107 may be a computing device that is outside of an enterprise or enterprise system associated with application environment 103. For example, the external user device 107 may be outside of an enterprise system or other firewall that protects application environment 103. External user device 107 may be or include a server, a desktop computer, a laptop computer, a tablet computer, a smart phone, a personal digital assistant (PDA), a cellular phone, and/or other computing device. In some implementations, internal user device 109 may be a computing device that is inside an enterprise or enterprise system associated with application environment 103. For example, the internal user device 109 may be inside of an enterprise system or other firewall that protects application environment 103. Internal user device 109 may be or include a server, a desktop computer, a laptop computer, a tablet computer, a smart phone, a personal digital assistant (PDA), a cellular phone, and/or other computing device. User may utilize external user devices 107 and/or internal user devices 109 to attempt to access resources 113 of enterprise environment 103. Similarly, referring to FIG. 1B, a user may attempt to access or unlock user device 151, which may be considered an access attempt.

When such access attempts are made, the user may be prompted to login using their username, password, rhythm information and/or other information. One or more GUIs 115 may be presented to the user enabling the user to provide such information. When the user provides rhythm information associated with an attempted login (in conjunction with or separate from username and/or password information), authentication module 105 receives the provided rhythm information and compares it with the stored rhythm information received in the initial stage (including any thresholds calculated therefor) and determines whether the provided rhythm information associated with the attempted login matches the stored rhythm information. If the provided rhythm information matches the stored rhythm information, the user may be logged in and permitted to access one or more services 113 or other aspects of computing environment 103 or user device 151. As discussed herein, in some implementations, login may be dependent on the user entering other information (e.g., username, password, etc.) that adequately authenticates the user.

The comparison of stored rhythm information as login information with received rhythm information provided by a user attempting to access a computing system may include the comparison of vectors. As discussed herein each of the stored rhythm information and the provided access attempt rhythm information may be converted to vectors that are then compared to determine whether to allow an access attempt. Different algorithms may be used to associate the distance of an attempted login (i.e., a test vector) to a stored base line rhythm sample or set of samples (i.e., stored information vector). The term “distance” refers to any number that can be used to gauge the likelihood that the test vector is from the original population (i.e., that whoever or whatever is attempting to login is the correct entity). For example, in some implementations, the “Mahalanobis distance” may be used. The Mahalanobis distance is a statistical technique that can estimate the likelihood that a test vector is in a population. The test vector (attempted user's entered rhythm information) of the systems and methods provided herein is a sequence of numerical data associated with events that occur when a user taps a rhythm via a switch, keyboard, touchscreen, or other data entry device.

In some embodiments, neural networks may be trained on stored rhythm information and used to match received rhythm information (i.e., a test vector) from a user attempting to access a computing system. In some implementations, one or more informal methods not based on any rigorous theory may also be used to match received rhythm information (i.e., a test vector) from a user attempting to access a computing system. For example, an average sequence of time intervals from stored rhythm information from initial stage login information input may be calculated. In order to measure the deviation of received rhythm information (i.e., a test vector) from a user attempting to access a computing system deviations of each individual tap or keystroke event may be added up (typically requiring the same total number of taps, but possibly allowing some variation) from its average value. These figures could be scaled up or down according to the number of keystrokes in the rhythm information.

In some implementations, authentication module 105 may assume that the intended rhythm to be stored as rhythm information for a user's login information obeys normal Western musical conventions, in which time signatures are from a small well-defined set (3/4, 4/4, 10/4, etc.) and most notes begin on a very limited set of possibilities within each measure. From several samples it is possible to identify the intended perfect canonical timing of a tapped rhythm. A variety of methods, including the above, can then be used to compare a test vector (i.e., received rhythm information from a user attempting to access a computing system) to the stored canonical version.

The comparison methods described above typically fall into two categories. The first category measures a distance between two data sets and is useful when there is room for a margin of error when comparing two data sets. The second method includes reducing two data sets to a specific form and directly comparing the respective forms for equality. A person having ordinary skill in the art will recognize that either category of comparison technique may be useful for comparing rhythm information.

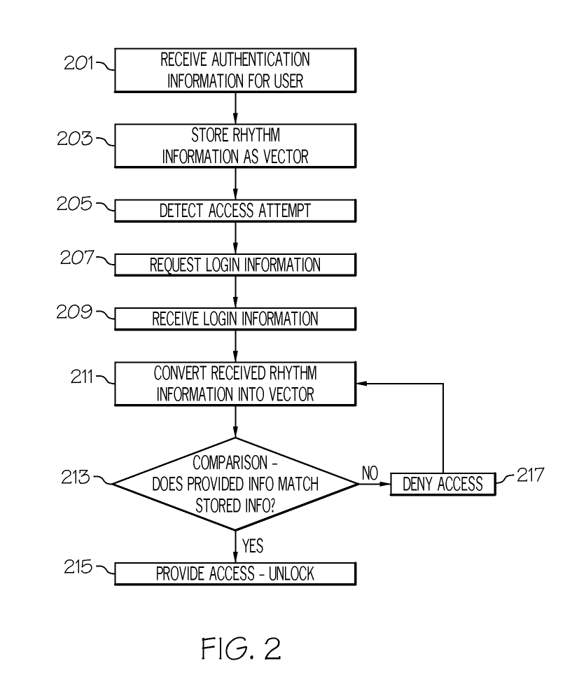

FIG. 2 illustrates a process 200, which is an example of a process for authentication to a computing environment or device using rhythm-based component. In some implementations, process 200 may include an operation 201, wherein in an initial stage of an authentication scheme, information is associated with a user that is to be granted access to a computing system (e.g., computing environment 103, user device 151). In some implementations, operation 201 may include presenting the user with one or more graphical user interfaces (e.g., a GUI 115) that enable the user to provide, select, or be assigned authentication information. As discussed herein, the authentication information may be or include rhythm information. In some implementations the authentication information may also include a username and/or password.

In some implementations, the user may provide the rhythm information to the computing system (e.g., authentication module 105) by providing a plurality of keystrokes, mouse “clicks,” taps on a touchscreen, or other input in a user-selected pattern. In some implementations, the user may be prompted (e.g., by a GUI 115) to provide the rhythm information multiple times. By providing the rhythm information multiple times, one or more thresholds may be calculated for the rhythm information so that imprecise rhythm information may be used to authenticate the user in future login attempts. In some implementations, even when only one iteration of rhythm information is provided, one or more thresholds may be calculated to allow authentication using imprecise input.

In an operation 203, the rhythm information input by the user during the initial stage may be stored (e.g., by authentication module 105 in database 117) as a vector. This may enable comparison of the stored rhythm information with rhythm information received as part of an access attempt. As discussed above, the stored rhythm information may be stored as any number of different vectors for this comparison. The stored vector may be stored along with any threshold information that is to be used during the comparison. As such, operation 203 may include the calculation of any thresholds to be used with the stored rhythm information during access attempts.

In an operation 205, an access attempt to the protected computer system is detected. For example, a user may be attempting to login to computing environment 103 or access device 151.

In an operation 207, the attempting user may be presented with one or more GUIs (e.g., GUIs 115) requesting that the attempting user provide adequate login information prior to receiving access. In some implementations, the requested login information may include rhythm information. In some implementations, the requested login information may include a username, a password, and/or other information in addition to the rhythm information.

In an operation 209, the computing system (and therefore authentication module 105) may receive the requested login information via the GUI. As described herein, the user may utilize keys on a keyboard, mouse buttons, a touchscreen, and/or other input devices to provide the requested login information, including rhythm information.

In an operation 211, the received rhythm information provided in conjunction with the login attempt may be converted into a vector to enable comparison with the stored rhythm information associated with the authorized user. The vector format into which the rhythm information associated with the login attempt is converted will correlate to the format in which the rhythm information associated with the authorized user is stored (e.g., in database 117).

In an operation 213, the received login information may be compared to stored login information. In some implementations, wherein multiple authorized users exist, this may include identifying a user associated with a username associated with provided login information (or otherwise identifying a user) and comparing provided rhythm information to stored rhythm information associated with the identified user. In some implementations such as, for example wherein a single user of a device (e.g., cell phone) exists, the authorized user's rhythm information is known.

The comparison of login information includes comparison of stored rhythm information associated with the authorized/identified user with the rhythm information associated with the access attempt. This may include comparing the stored vector of operation 203 with the converted vector of operation 211. As described above, in some implementations, this comparison may include calculating a distance between the two vectors and may utilize a Mahalanobis distance or other distance calculation techniques. In some implementations, this comparison may include neural vector or rhythm matching techniques. As discussed herein the comparison may also take into account any thresholds associated with the stored rhythm information that enable determination of a match when the provided rhythm information does not exactly the stored rhythm information.

If a password is used with the login information, operation 213 may include comparing a password associated with the user to a provided password or comparing other provided information to other stored information.

If the provided rhythm information matches the stored login information the user may be provided with access to the computing system (e.g., computing environment 103, user device 151) in an operation 215. If, however, the provided login information does not match the stored login information, the user may be prevented from accessing the computing system in an operation 217. In some implementations the user may be prompted to reenter the login information so that the compassion can be made using different login information or the access attempt may otherwise be repeated.

Use of rhythm information alone (i.e., without specific keystroke information) for authentication purposes may be advantageous in certain circumstances wherein the use of specific keys or parts of a touchscreen is inconvenient or difficult to achieve, such as, for example, when a user is driving or otherwise performing multiple tasks at once or when the user is disabled. Furthermore, the use of rhythm information alone is easy to remember for users burdened with many passwords. Furthermore the use of rhythm information alone is unique in that the user typically will not or cannot write down the precise rhythm information used to authenticate, providing more security. Additionally, rhythm information is versatile and can be input with a great variety of input devices.

Implementations described in this disclosure may be made in hardware, firmware, middleware, software, or various combinations thereof. The technology disclosed herein may also be implemented as computer-readable instructions stored on a tangible computer-readable storage medium which may be read and executed by one or more processors. A computer-readable storage medium may include various mechanisms for storing information in a form readable by a computing device. For example, a tangible computer-readable storage medium may include optical storage media, flash memory devices, and/or other storage mediums. Further, firmware, software, routines, or instructions may be described in the above disclosure in terms of specific exemplary aspects and implementations of the technology, and performing certain actions. However, it will be apparent that such descriptions are merely for convenience, and that such actions may in fact result from computing devices, processors, controllers, or other devices executing firmware, software, routines or instructions.

The systems described herein are exemplary system configurations. Other configurations may exist. Those having skill in the art will appreciate that the invention described herein may work with various configurations. Accordingly, more or less of the aforementioned system components may be used and/or combined in various embodiments. Furthermore, various operations of the methods described herein, while described in a particular order, may be performed in different orders as would be appreciated by those having skill in the art. In some embodiments, more of less of the described operations may be used.

Other implementations, uses, and advantages of the disclosed technology will be apparent to those skilled in the art from consideration of the specification and practice of the invention disclosed herein. The specification should be considered exemplary only, and the scope of the technology disclosed herein is accordingly intended to be limited only by any associated claims.

What is claimed is:

1. A method for providing authentication to a computing system, the method executed by a processor configured to perform a plurality of operations, the method comprising:
obtaining a first vector that includes information relating to a rhythm of a first plurality of user input events, wherein the first vector is associated with a user authorized to use the computing system;
receiving a second plurality of user input events associated with an attempt to access the computing system;
converting the second plurality of user input events to a second vector, wherein the second vector includes information relating to a rhythm of the second plurality of user input events;
comparing the first vector to the second vector; and
determining if a match exists between the first vector and the second vector.

2. The method of claim 1, further comprising:
receiving the first plurality of user input events from the user during a window of time; and
storing data relating to the first plurality of user input events as the first vector.

3. The method of claim 2, wherein receiving the first plurality of user input events further comprises receiving multiple iterations of the first plurality of user input events,
wherein storing the first plurality of user input events as the first vector further comprises storing a threshold derived from the multiple iterations of the first plurality of user input events, and
wherein determining if a match exists between the first vector and the second vector includes determining if the first vector matches the second vector within the threshold.

4. The method of claim 1, further comprising granting the attempt to access the computing system when the second vector matches the first vector and denying the attempt to access the computing system when the second vector does not match the first vector.

5. The method of claim 1, wherein comparing the first vector to the second vector includes calculating a distance between the first vector and the second vector.

6. The method of claim 5, wherein calculating the distance between the first vector and the second vector includes calculating a Mahalanobis distance between the first vector and the second vector.

7. The method of claim 1, wherein receiving the second plurality of user input events associated with an attempt to access the computing system further comprises receiving a username associated with the attempt to access the computing system and wherein comparing the first vector to the second vector further comprises locating the first vector using the received username.

8. The method of claim 1, wherein the computing system is a user device or a computing environment remote from a device associated with the attempt to access the computing system.

9. The method of claim 1, wherein the first plurality of user input events includes input of a plurality of keystrokes at a keyboard by a user or touching by a user of a touch screen a plurality of times.

10. The method of claim 9, further comprising determining an up event and a down event for each user keystroke or user touch of the touch screen.

11. The method of claim 1, wherein the first vector also includes spatial information relating to the first plurality of user input events, and the second vector also includes spatial information relating to the second plurality of user input events.

12. A system to provide authentication to a computing system, comprising:
a data storage device; and
a processor configured to:
obtain a first vector that includes information relating to a rhythm of a first plurality of user input events, wherein the first vector is associated with a user authorized to use the computing system;
receive a second plurality of user input events associated with an attempt to access the computing system;
convert the second plurality of user input events to a second vector, wherein the second vector includes information relating to a rhythm of the second plurality of user input events;
compare the first vector to the second vector; and
determine if a match exists between the first vector and the second vector.

13. The system of claim 12, wherein the processor is further configured to:
receive the first plurality of user input events from the user during a window of time; and
store data relating to the first plurality of user input events in the data storage device as the first vector.

14. The system of claim 13, wherein receipt of the first plurality of user input events comprises receipt of multiple iterations of the first plurality of user input events,
wherein storage of the first plurality of user input events as the first vector comprises storage of a threshold derived from the multiple iterations of the first plurality of user input events, and
wherein the determination of whether a match exists between the first vector and the second vector includes a determination of whether the first vector matches the second vector within the threshold.

15. The system of claim 12, wherein the processor is further configured to grant the attempt to access the computing system when the second vector matches the first vector and deny the attempt to access the computing system when the second vector does not match the first vector.

16. The system of claim 12, wherein the comparison of the first vector to the second vector includes a calculation of a distance between the first vector and the second vector.

17. The system of claim 16, wherein the calculation of the distance between the first vector and the second vector includes a calculation of a Mahalanobis distance between the first vector and the second vector.

18. The system of claim 12, wherein receipt of the second plurality of user input events associated with an attempt to access the computing system further comprises receipt of a username associated with the attempt to access the computing system and wherein the comparison of the first vector to the second vector further comprises the identification of the first vector using the received username.

19. The system of claim 12, wherein the computing system is a user device or a computing environment remote from a device associated with the attempt to access the computing system.

20. The system of claim 12, wherein the first plurality of user input events include input of a plurality of keystrokes at a keyboard by a user or touching by a user of a touch screen a plurality of times.

21. The system of claim 20, wherein the processor is further configured to determine an up event and a down event for each user keystroke or user touch of a touch screen.

22. The system of claim 12, wherein the first vector also includes spatial information relating to the first plurality of user input events, and the second vector also includes spatial information relating to the second plurality of user input events.

23. A method for providing authentication to a computing system, the method executed by a processor configured to perform a plurality of operations, the method comprising:
receiving a plurality of user input events associated with an attempt to access the computing system;
converting the plurality of user input events to a first vector, wherein the first vector includes information relating to a rhythm of the plurality of user input events;
comparing the first vector to a second vector, the second vector information including information relating to a rhythm of another plurality of user input events associated with a user authorized to use the computing system; and
determining if a match exists between the first vector and the second vector.
